(19) United States
(12) Patent Application Publication
(10) Pub. No.: US 2008/0052237 A1
(43) Pub. Date: Feb. 28, 2008

(54) Billing Method And Arrangement In A Peer-To-Peer Network

(76) Inventors: Jens-Uwe Busser, Munchen (DE); Gerald Liebe, Strausberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/660,816

(22) PCT Filed: Aug. 12, 2005
(86) PCT No.: PCT/EP05/53986

§ 371 Date: Sep. 10, 2007

(30) Foreign Application Priority Data
Aug. 23, 2004 (DE) 10 2004 040 768.1

(51) Int. Cl. G06Q 30/00

(52) U.S. Cl. 705/50

(57) ABSTRACT

In peer-to-peer networks, the services are not provided by central units, but the individual subscriber peers provide them reciprocally, with digitally signed data being stored as resources in the peer-to-network. The data can act as non-rejectable data for billing information if they are transmitted to central collection points. For optimization, only the hash values of the data records and appropriate information that is relevant to the billing process are signed instead of the data records themselves.

### CROSS REFERENCE TO RELATED APPLICATIONS

This application is the US National Stage of International Application No. PCT/EP2005/053986, filed Aug. 12, 2005 and claims the benefit thereof. The International Application claims the benefits of German application No. 102004040768.1 DE filed Aug. 23, 2004, both of the applications are incorporated by reference herein in their entirety.

### FIELD OF INVENTION

The present invention relates to a billing method and arrangement in a peer-to-peer network.

### SUMMARY OF INVENTION

A peer-to-peer network based on distributed hash tables (DHTs) is given. An overview relating to such networks is given in [1] for instance. The representation of an exemplary peer-to-peer network can be inferred from FIG. 1. In this network, information (referred to subsequently as resources) is stored decentrally on said units, the “P2P address” (e.g. the hash value on the IP address and port number) of which correspond best with the key ID of the resource (e.g. hash value of a search term etc.), measured at the respective metrics of the P2P algorithms [2, 3].

The devices (referred to subsequently as peers or stations) in this network should authenticate and authorize themselves and/or the messages generated by them by means of digital signatures and certificates. These certificates are issued in advance by a trustworthy, central point (Certificate Authority CA) and are introduced into the P2P network as resources [1].

If specific data DAT (own user profile, messages to absent peers, etc.) are introduced into the P2P network as resources, they must be digitally signed by generating PeerA. To this end, PeerA calculates a cryptographic hash value (e.g. with a hash method SHA-1) of the data DAT, and signs this hash value subsequently with its private key P_{A} [1]. This complete data set must also be transmitted to a collection point for billing purposes. Even if a peer wants to receive a specific resource (third party user profile, a message stored for him/her, etc.), from another peer, he must produce a signed request. This enables non-rejectable consumer-related billing to be carried out, provided these signed resources are sent completely to a central collection point, which carries out the evaluations.

This can however result in considerable problems, if these data sets are quite large (several MB). Even if billing information does not need to be collected in real time, the collection points must however receive and evaluate all resources of a large number of peers at least once, for the most part even multiple times.

If the complete resources are not transmitted, but only their hash value with the signature, the following manipulations would be possible:

Case 1: PeerB could collect signatures from PeerA, which has produced these with the same private key P_{A} for other applications or at earlier times, and then store them as resources in the P2P network with PeerA liable to pay costs.

Case 2: On the other hand, PeerA could claim that he would not have ordered the services billed to him and would have produced the signatures for other applications. PeerA could thus reject the billing as faulty.

As it is no longer possible to reconstruct the original message from the hash value, a distinction between case 1 and case 2 is not possible, when the original data set is no longer available. The non-repudiation of the services provided would thus no longer be ensured.

An object underlying the invention is to specify a method and an arrangement which enable non-repudiable billing in a peer-to-peer network.

This object is achieved on the basis of the method and arrangement according to the claims.

The method according to the invention is characterized in that the size of the data to be transmitted to the collection point is considerably reduced, and non-rejectable billing is nevertheless ensured.

To this end, in accordance with the invention, the information INFO required for the billing is firstly extracted from the data set DAT, which is to be stored as a resource or is requested with the data of another peer, for instance the name of the signing peer, type of service, point in time of its performance, size of the stored voice message, realization urgency etc. Furthermore, the hash value of the data set is calculated. This hash value is then hashed once more together with the billing information and only then is this signed. The data set is then stored together with the billing information and the signature, e.g. as a resource in the P2P network. The collection point then no longer requires the data DAT itself, which could be far more detailed than the rest. It only requires the hash value of the data DAT, the billing information INFO as well as the signature over both. A maximum of approximately 500 bytes must thus be transmitted to the collection point. A rejection due to lack of evidence is nevertheless not possible.

If PeerB now sends old billing information from PeerA to the collection point, this can be recognized on the basis of the point in time noted therein. If PeerB has signatures generated by PeerA, PeerB is unable to generate any suitable billing information for these signatures. In the case of all valid signed billing information, it is ensured that only PeerA could itself have generated it. PeerA can then no longer reject the billing as faulty. The computing outlay of the peers increases from 1 hash and 1 signature to 2 hashes and 1 signature. This is however negligible, since a signature calculation is significantly more expensive than a hash value calculation and each peer only carries out very few calculations in comparison with the collection point anyway. The computational outlay of the collection point nevertheless remains unchanged with 1 hash and 1 signature.

### BRIEF DESCRIPTION OF THE DRAWINGS

Further advantages and details of the invention are explained with reference to an exemplary embodiment based on the FIGS. 1 to 3, in which:

FIG. 1 shows an example of a peer-to-peer network in which the method according to the invention comes into effect

FIG. 2 shows the representation of an example of a resource signed according to previous methods.

FIG. 3 shows a tabular representation of an exemplary embodiment of the method according to the invention.

### DETAILED DESCRIPTION OF INVENTION

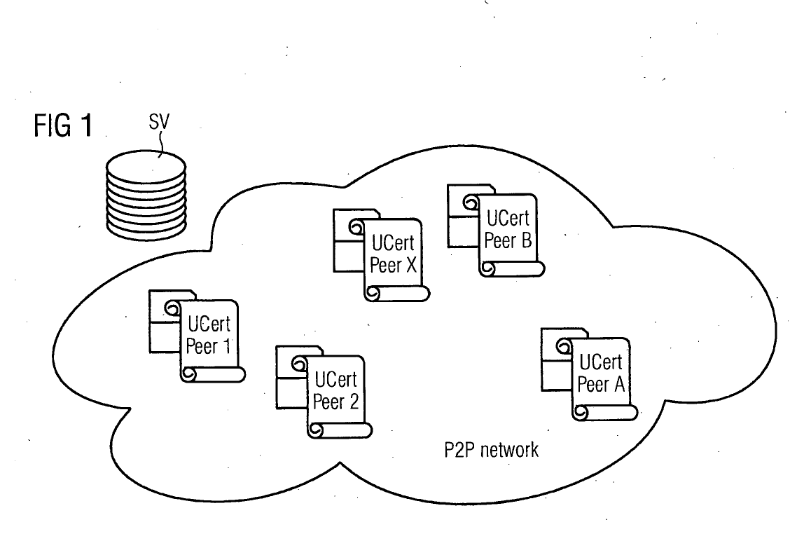

FIG. 1 shows an example of a peer-to-peer network P2P network. Such a network is characterized inter alia in that individual stations Peer1, Peer2 . . . PeerB provide and also use billable services. Based on an arrangement of this type, the invention intends to ensure non-repudiable billing, which also reduces the outlay and/or saves on resources compared with the hitherto known methods.

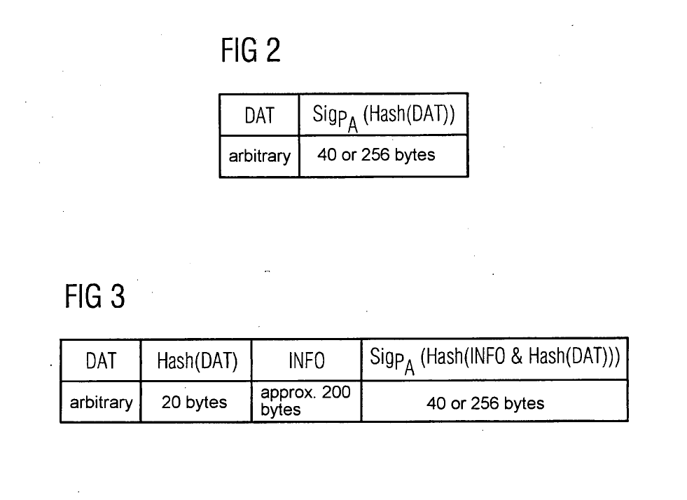

The conventional methods are disadvantageous in that data required for billing features a high byte number, as is shown in FIG. 2, the entire station-related data is hashed and is above all transmitted. In addition, there is no non-repudiability.

In contrast, data INFO required for the billing is extracted from the station-related data DAT of a station PeerA in accordance with the invention. Finally, a first hash value is formed from the station-related data and a second hash value is generated from this first hash value and the necessary data INFO, said second hash value being available in a signed form for billing with the key P_{A} of the peer PeerA.

The method according to the invention produces an essential advantage in that signed data sets, which must be transmitted to central collection points for billing purposes, are considerably reduced in size. In addition, no additional computational outlay is required for a collection point SV involved in the billing. Finally, only an additional hash value evaluation is needed in each instance for the peers Peer1, Peer2, PeerA . . . PeerB.

The invention should thus not be restricted to the explained exemplary embodiments, but should instead comprise all variations which can be generated within the scope of the ability of the person skilled in the art, said variations comprising the elements essential to the invention—extracting the data needed for carrying out the billing from the station-related data, hashing the station-related data, as well as hash value formation from the necessary data and the hashed station-related data.

### Literature

[1] Thomas Friese: “Selbstorganisierende Peer-to-Peer Netzwerk” [Self-organizing peer-to-peer networks], Diploma thesis at the Philipps Universität Marburg, March 2002

[2] Petar Maymounkov, David Mazieres: “Kademlia: A Peer to Peer Information System based on the XOR Metric”, New York University

[3] Stoica, Morris, Karger, Kaashoek, Balakrishnan: “Chord: A Scalable Peer-to-Peer Lookup Service for Internet Applications”, MIT Laboratory for Computer Science, 2001.

1.-2. (canceled)

3. A billing method in a peer-to-peer network comprising a plurality of stations, where at least one first part of the stations at least temporarily provides a billable service for at least one second part of the stations, and where station-related billing data accumulates by using the service, comprising:
forming a first hash value from a data set via a cryptographic hash function within the scope of the billing of the service used;
extracting from the data set a data part that is required for a billing;
forming a second hash value from the data part and the first hash value via a cryptographic hash function;
signing the second hash value; and
sending the signed second hash value so that the billing is based on the signed second hash value.

4. An arrangement for billing in a peer-to-peer network with a plurality of stations with at least one first part of the stations at least temporarily providing a billable service for at least one second part of the stations, with station-related billing data accumulating by using the service, comprising:
a first hash value formed from a data set via a cryptographic hash function within the scope of the billing of the service used,
a data extracted from the data set part that is required for a billing;
a second hash value formed from the data part and the first hash value via a cryptographic hash function; and
a signed hash value formed by signing the second hash value,
wherein the billing is based on the signed second hash value.
